(19) United States
(12) Patent Application Publication
(10) Pub. No.: US 2017/0180279 A1
(43) Pub. Date: Jun. 22, 2017

(54) PROVIDING INTEREST BASED NAVIGATION OF COMMUNICATIONS

(71) Applicant: MICROSOFT TECHNOLOGY LICENSING, LLC, Redmond, WA (US)

(72) Inventors: Tali Roth, Seattle, WA (US); Nicholas Smith, Redmond, WA (US); Dylan Symington, Seattle, WA (US)

(21) Appl. No.: 14/970,576

(22) Filed: Dec. 16, 2015

(51) Int. Cl. H04L 12/58; G06F 17/30; G06F 17/27; G06Q 10/10

(52) U.S. Cl. CPC H04L 51/046; G06Q 10/107; G06F 17/30598; G06F 17/2705; H04L 51/22

(57) ABSTRACT

Interest based navigation of communications is provided. In some examples, an application, such as a communication application, receives a communication from a source. The communication is parsed to identify an interest and a participant account associated with the communication. The communication application assigns the communication to an interest container associated with the interest and to an account container associated with the participant account. Furthermore, the communications are presented in the interest container and in the account container within a navigation user interface (UI).

### BACKGROUND

Communication applications, such an email application, are provided by a computing device to allow users to communicate with each other rapidly through electronic messaging. Users may have several email accounts, such as a work email account and a personal email account. Folders, such as an inbox folder, a group folder, etc., may be used to organize and group emails within each of the accounts. However, the users may have to access both the work email account and the personal email account to retrieve the emails associated with a group.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to interest based navigation of communications. In some examples, a communication application may receive a communication from a source. The communication may be parsed to identify an interest and a participant account associated with the communication. The communication application may assign the communication to an interest container associated with the interest and to an account container associated with the participant account. The communication may presented in the interest container and in the account container within a navigation user interface (UI).

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example computing environment for providing interest based navigation of a communication, according to embodiments;

FIG. 2 is a display diagram illustrating an example navigation user interface (U) associated with providing interest based navigation of a communication, according to embodiments;

FIG. 3 is a block diagram illustrating steps to parse a communication to identify an interest and a participant account associated with the communication, according to embodiments;

FIG. 4 is a display diagram illustrating actions performed on a navigation user interface (UI) associated with providing interest based navigation of a communication, according to embodiments;

FIG. 5 is a simplified networked environment, where a system according to embodiments may be implemented;

FIG. 6 is a block diagram of an example computing device, which may be used for providing interest based navigation of a communication, according to embodiments; and

FIG. 7 is a logic flow diagram illustrating a process for providing interest based navigation of a communication, according to embodiments.

### DETAILED DESCRIPTION

As briefly described above, interest based navigation of communications may be provided. In some examples, a communication application may receive a communication from a source. The source may include a directory service, an online service, and/or a local data source, among others. The communication may be parsed to identify an interest and a participant account associated with the communication. The interest may include a favorite interest and/or a trending interest, among others.

The communication application may assign the communication to an interest container associated with the interest and to an account container associated with the participant account. The interest container may include a favorite container and/or a trending container, among others. The communication may be presented in the interest container and in the account container within a navigation user interface (UI).

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing interest based navigation of communications. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that allow the application or service to interact or communicate with one or more other applications and services managed by separate entities.

While example implementations are described using communications herein, embodiments are not limited to communications. Interest based navigation of communications may be implemented in other environments, such as instant messages, data sharing, application sharing, online conferencing, and similar communications, where communication data may be exchanged.

The technical advantages of providing interest based navigation of communications may include, among others, increased efficiency of participant interactions with a computing device. Processing and network bandwidth may be reduced, as a communication application may be used to view organized communications from several sources on a navigation user interface (UI). Further, memory and processor burden may be reduced by decreasing a number of actions performed on the computing device.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with the communications.

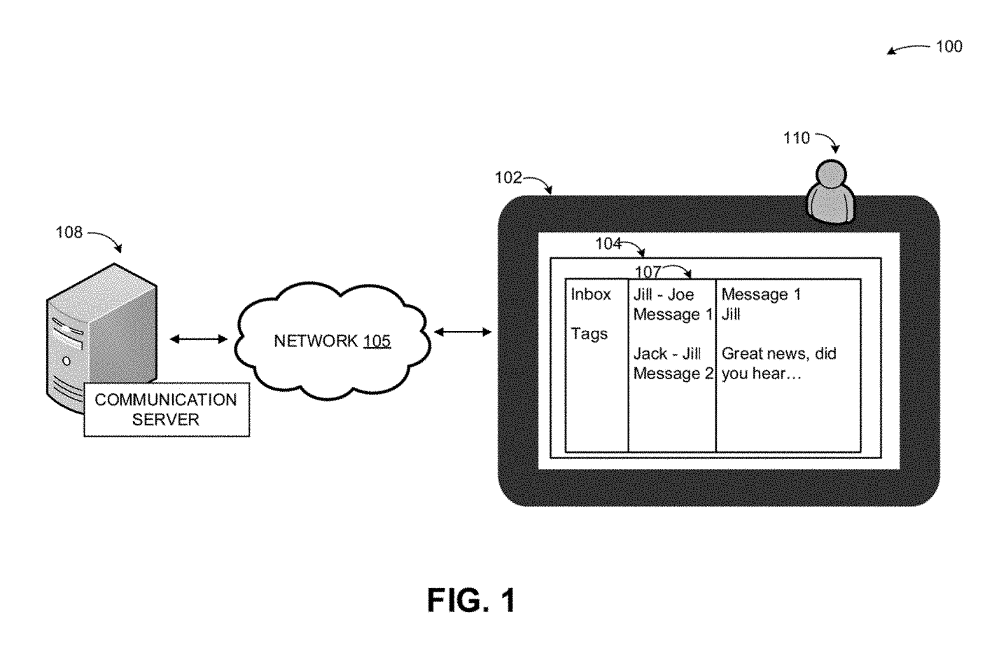

FIG. 1 is a conceptual diagram illustrating an example computing environment for providing interest based navigation of a communication, according to embodiments.

As shown in a diagram 100, a computing device 102 may execute a communication application. The computing device 102 may include a display device, such as a touch enabled display component, and a monitor, among others, to provide the communication application to a participant 110. The computing device 102 may include a desktop computer, a laptop computer, a tablet, a smart phone, and a wearable computer, among other similar computing devices, for example.

In some examples, the communication application may be executed on a communication server 108. The communication server 108 may include a web server or a document server, among others. The computing device 102 may communicate with the communication server 108 through a network 105. The network 105 may provide wired or wireless communications between nodes, such as the computing device 102 or the communication server 108.

In other examples, the communication application may be provided by a third party service, web applications, and/or a datacenter, among others. Local access to the communication application may be provided by locally installed rich clients (a local version of the communication application) or generic applications, such as a browser on the computing device 102. The communication application executed on the communication server 108 represents a visual way to view a communication 107. The communication 107 may include an instant messaging communication, an email, a text message, an audio message, a video message, and/or a graphical message, among others.

The communication application may receive the communication 107 from a source. The source may include a directory service, an online service, and/or a local data source, among others. The communication 107 may be parsed to identify an interest and a participant account associated with the communication 107. The interest may be identified as a favorite interest and/or a trending interest, among others.

Next, the communication application may assign the communication 107 to an interest container associated with the interest and to an account container associated with the participant account. In other examples, the communication application may assign the communication 107 to the interest container associated with the interest. In a further example, the communication application may assign the communication 107 to the account container associated with the participant account. The interest container may include a favorite interest container and/or a trending interest container, among others. The communication application may present, on the display device, the communication 107 in the interest container and in the account container within a navigation user interface (UI) 104.

While the example system in FIG. 1 has been described with specific components including the computing device 102, the communication application, and the communication server 108, embodiments are not limited to these components or system configurations and can be implemented with other system configuration employing fewer or additional components.

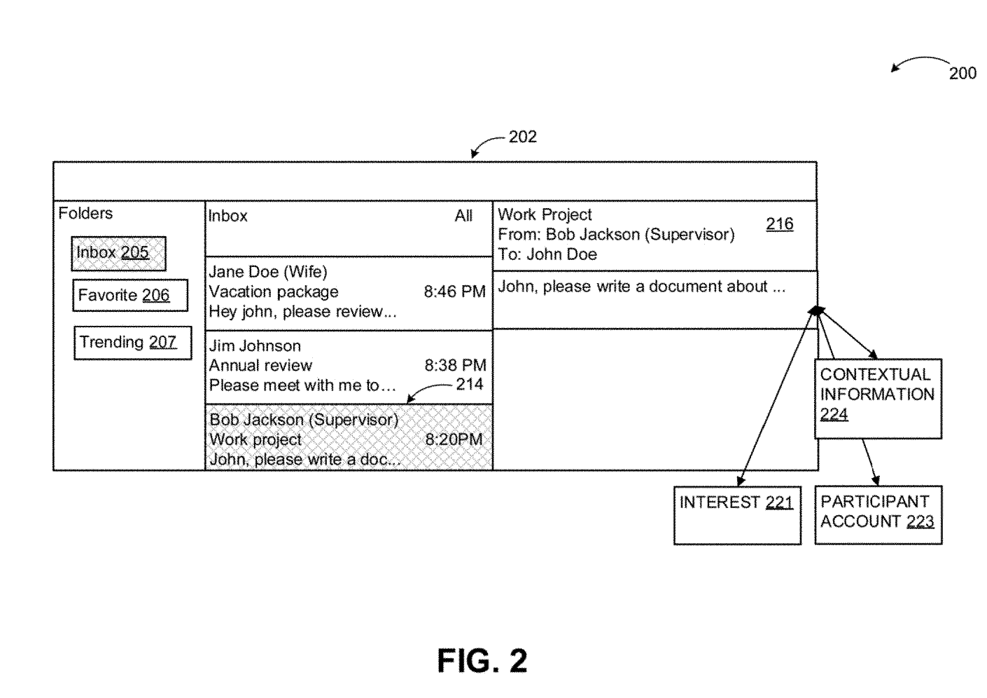

FIG. 2 is a display diagram illustrating an example navigation user interface (UI) associated with providing interest based navigation of a communication, according to embodiments.

In a diagram 200, a computing device may provide a communication application 202 to a participant. The communication application 202 may receive a communication 216 from a source. A summary view 212 of the communication 216 may be displayed in a navigation user interface (UI) 202. The communication 216 may include an email, for example.

The communication application 202 may parse the communication 216 to identify an interest 221 and a participant account 223 associated with the communication 216. The communication application may assign the communication 216 to an interest container (e.g., a favorite folder 206) associated with the interest 221. The communication 216 may also be assigned to an account container associated with the participant account 223.

In some examples, the communication application 202 may detect an input action on a selected summary view 214 to display the communication 216. In response to the input action, the communication 216 may be displayed. The communication application 202 may also extract contextual information 224 from the communication 216. The contextual information 224 may be analyzed to count a number of interactions with the communication 216. The number of interactions may include a number of comments, a number of shares, and/or a number of social media identifiers associated with the communication 216, among others.

The communication application may detect the number of interactions exceed a threshold. The threshold may include a participant (or application) provided value to exceed in order to assign a communication in a favorite container. After the number of interactions exceed the threshold, the communication application 202 may label the communication 216 with a favorite interest (as the interest 221) and may assign the communication 216 to a favorite container 206 (e.g. a favorite folder 206) as the interest container.

In other examples, the communication application may detect an increase in a number of accesses to the communication during a time period. In response, the communication application may label the communication with a trending interest (as the interest 221). The communication application may assign the communication to a trending container (e.g., a trending folder 207) as the interest container.

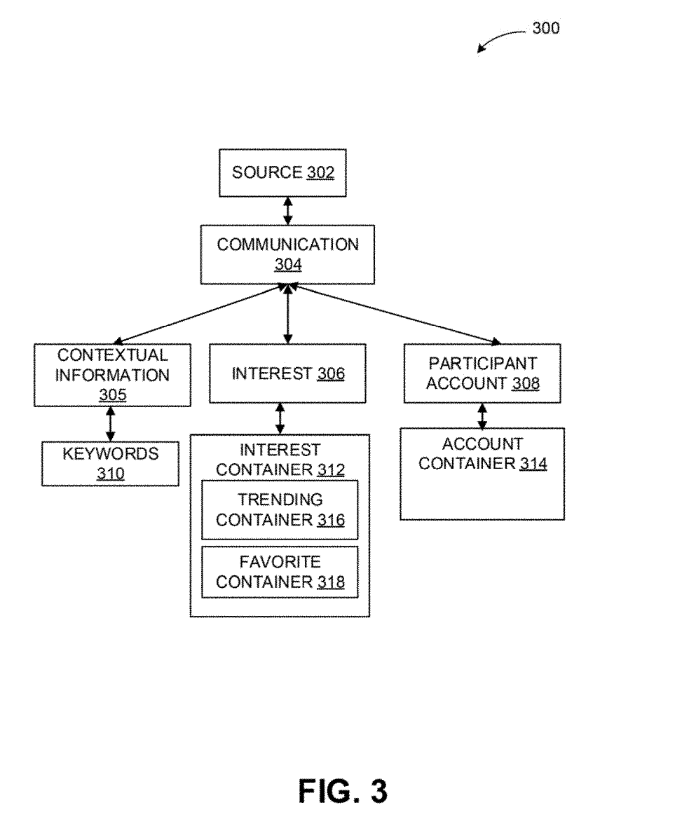

FIG. 3 is a block diagram illustrating steps to parse a communication to identify an interest and a participant account associated with the communication, according to embodiments.

In a diagram 300, a computing device may execute a communication application. The computing device may provide the communication application to a participant. The communication application may receive a communication 304 from a source 302. The communication 304 may be displayed in a navigation user interface (UI). The communication 304 may include an email, for example.

The communication application may parse the communication 304 to identify an interest 306 and a participant account 308 associated with the communication 304. In some examples, the communication application may extract contextual information 305 from the communication 304. The contextual information 305 may include textual information, graphical information, audio information, and/or video information, among other information.

The contextual information 305 may be analyzed to count a number of interactions with the communication 304. The number of interactions may include a number of comments, a number of shares, and/or a number of social media identifiers associated with the communication 304, among others. The communication application may detect the number of interactions exceed a threshold. The communication application may label the communication 304 with a favorite interest as the interest 306 and may assign the communication 304 to a favorite container 318 as an interest container 312.

In other examples, the communication application may identify keywords 310 in the communication 304. In response, the communication application may analyze a number of actions associated with the keywords 310. The actions may include a click action, an input action, a view of a search history, a search action, a copy action, and/or a paste action, among others. The communication application may detect the number of actions exceed a threshold. In response, the communication 304 may be labeled with a favorite interest. Next, the communication application may assign the communication 304 to the favorite container 318.

In further examples, the communication application may identify the interest 306 associated with the communication 304 as a trending interest. The communication application may assign the communication 304 to a trending container 316 as the interest container 312.

The communication application may assign the communication 304 to the interest container 312 associated with the interest 306 and to an account container 314 associated with the participant account 308. The communication application may present the communication 304 in the interest container 312 and the communication 304 in the account container 314 within a navigation user interface (UI) of the display device.

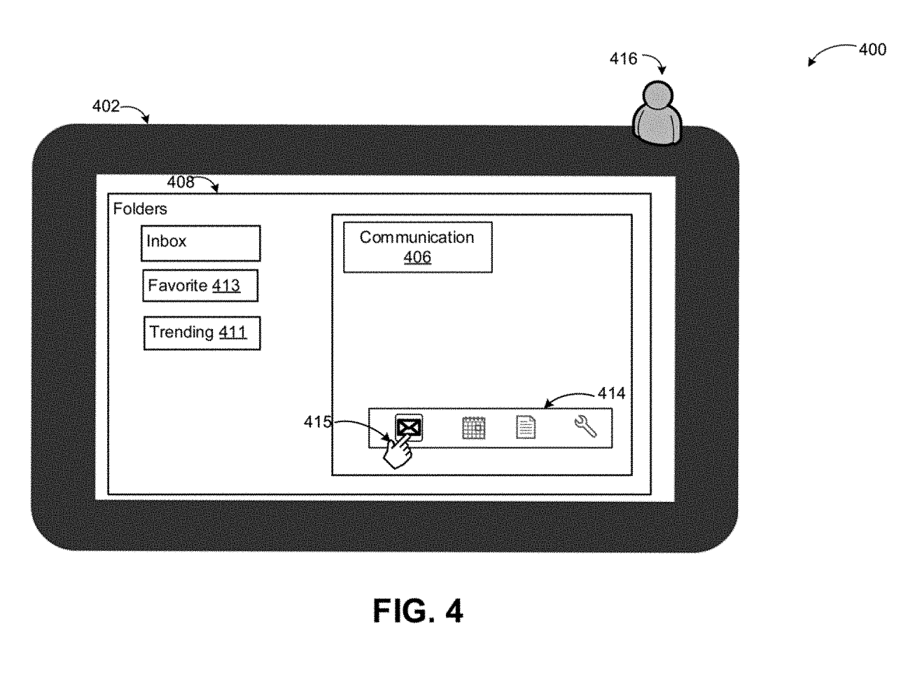

FIG. 4 is a display diagram illustrating actions performed on a navigation user interface (UI) associated with providing interest based navigation of a communication, according to embodiments.

In a diagram 400, a computing device 402 may provide a communication application 408 to a participant 416. In some examples, the communication application 408 may identify an interest associated with a communication 406 as a favorite interest. In response, the communication application may assign the communication 406 to a favorite container 413 as the interest container.

The communication application 408 may also provide control elements 414. The communication application 408 may also detect a customization request 415 (e.g., a customization input) on the control elements 414 to reassign the communication 406 to a trending container 411. In response, the communication application 408 may change the interest associated with the communication 406 to a trending interest from the favorite interest. The communication 406 may also be reassigned to the trending container 411 from the favorite container 413.

The communication application may also detect another customization input to modify the communication 406. The other input may include a press and hold action, a press and hold action combined with a swipe action, the swipe action, a keyboard entry combination, a hovering action by a mouse input, a press and hold action and a hovering action by a pen input, a tap action, an accelerometer sensor based input, an orientation sensor based input, an optically captured gesture, and/or a time based input, among other examples. In response, the communication application may execute the other customization input and may save the modification to the communication 406.

In further examples, the communication application may identify the interest associated with the communication 406 as a trending interest. Next, the communication 406 may be assigned to the trending container 411 as the interest container. The communication application 408 may then detect the customization request to reassign the communication 406 to the favorite container 413. In response, the communication application may change the interest associated with the communication 406 to a favorite interest from the trending interest. The communication application 408 may also reassign the communication 406 to the favorite container 413 from the trending container 411.

In additional examples, the communication application 408 may receive another communication from another source. The communication application may parse the other communication to identify another interest and another participant account associated with the other communication. The communication application may assign the other communication to another interest container associated with the other interest and to another account container associated with the other participant account.

In some examples, the communication application 408 may present the other communication in the other account container within a navigation UI. In response to detecting an unread status of the other communication, the communication application may present an indicator in the navigation UI to notify the participant 416 that the other communication is unread. The communication application may also detect an action on the other communication in the other account container. In response to the other action, the communication application 408 may present the other communication within a reading UI.

The example scenarios and schemas in FIG. 1 through FIG. 4 are shown with specific components, data types, and configurations. Embodiments are not limited to systems according to these example configurations. Interest based navigation of communications may be implemented in configurations employing fewer or additional components in applications and user interfaces. Furthermore, the example schema and components shown in FIG. 1 through FIG. 4 and their subcomponents may be implemented in a similar manner with other values using the principles described herein.

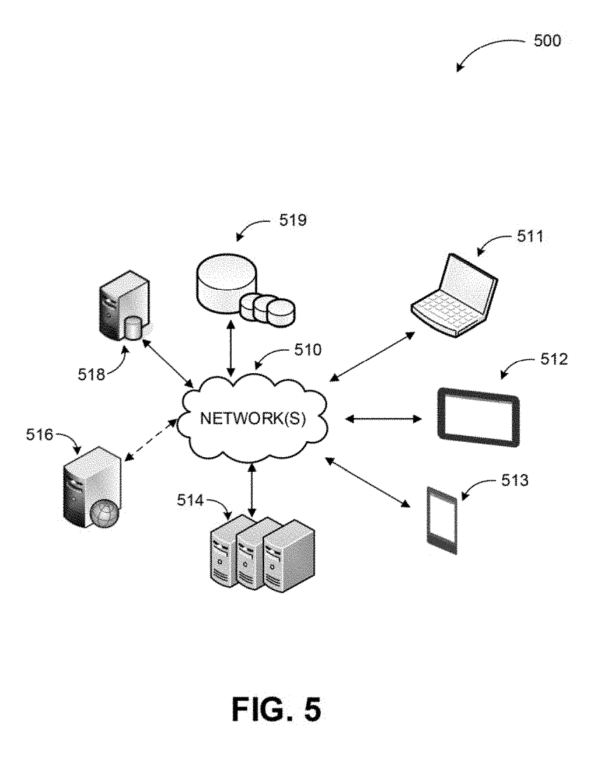

FIG. 5 is a simplified networked environment, where a system according to embodiments may be implemented.

As shown in a diagram 500, a computing device may execute a communication application. The computing device may include a display device, such as a touch enabled display component, and a monitor, among others, to provide the communication application to a participant. In examples, a communication service may be implemented via software executed over the servers 514. The platform may communicate with client applications on individual computing devices such as a smart phone 513, a mobile computer 512, or desktop computer 511 (‘client devices’) through network(s) 510. The servers 514 may include one or more communication servers 516, where at least one of the one or more communication servers 516 may be configured to execute one or more applications (i.e. the communication application) associated with a communication service.

In other examples, the communication service may be provided by a third party service or may include a web application. The communication service may store data associated with the communications in a data store 519 directly or through a database server 518. Client applications executed on client devices 511-513 may be enabled to receive the communication data and render the navigation UI displaying information associated with captured communications.

Client applications executed on any of the client devices 511-513 may facilitate communications via application(s) executed by the one or more communication servers 516, or on an individual communication server. A communication application may receive a communication from a source. Next, the communication may be parsed to identify an interest and a participant account associated with the communication. The communication may be assigned to an interest container associated with the interest and to an account container associated with the participant account. Furthermore, the communication application may present the communication in the interest container and the communication in the account container within a navigation user interface (UI). The communication application may store the communication data associated with the communications in the data store 519 directly or through database server 518.

The network(s) 510 may comprise any topology of servers, clients, Internet service providers, and communication media. A system according to embodiments may have a static or dynamic topology. The network(s) 510 may include secure networks such as an enterprise network, an unsecure network such as a wireless open network, or the Internet. The network(s) 510 may also coordinate communication over other networks such as Public Switched Telephone Network (PSTN) or cellular networks. Furthermore, the network(s) 510 may include short range wireless networks such as Bluetooth or similar ones. The network(s) 510 provide communication between the nodes described herein. By way of example, and not limitation, the network(s) 510 may include wireless media such as acoustic, RF, infrared and other wireless media.

A textual scheme, a graphical scheme, an audio scheme, an animation scheme, a coloring scheme, a highlighting scheme, and/or a shading scheme may be employed to further enhance participant interaction between information associated with the communications and the navigation UI.

Many other configurations of computing devices, applications, data sources, and data distribution systems may be employed for providing interest based navigation of communications. Furthermore, the networked environments discussed in FIG. 5 are for illustration purposes only. Embodiments are not limited to the example applications, modules, or processes.

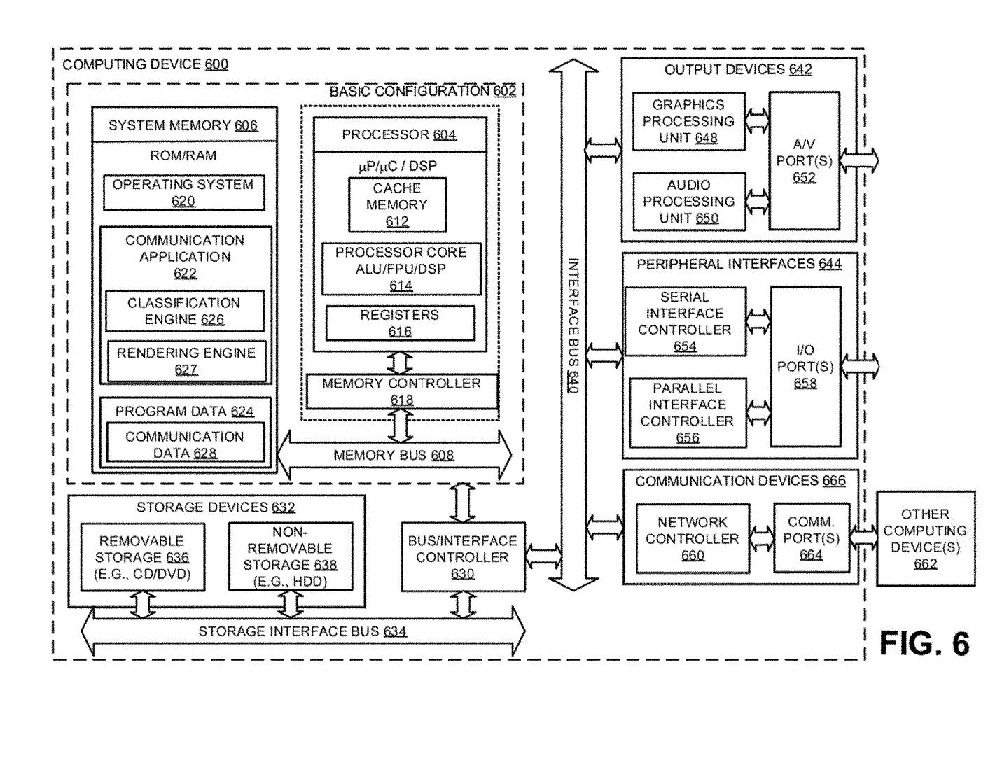

FIG. 6 is a block diagram of an example computing device, which may be used for providing interest based navigation of a communication, according to embodiments.

For example, a computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The example basic configuration 602 may be illustrated in FIG. 6 by those components within the inner dashed line.

Depending on the desired configuration, the processor 604 may be of any type, including but not limited to a microprocessor (P), a microcontroller (μC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations, the example memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication application 622, and a program data 624. The communication application 622 may include a classification engine 626 and a rendering engine 627.

The classification engine 626 may receive a communication from a source and may parse the communication to identify an interest and a participant account associated with the communication. The classification engine 626 may assign the communication to an interest container associated with the interest and to an account container associated with the participant account. The rendering engine 627 may present the communication in the interest container and the communication in the account container within a navigation user interface (UI).

Components of the communication application 622 (such as the navigation UI) may also be displayed on a display device associated with the computing device 600. An example of the display device may include a hardware screen that may be communicatively coupled to the computing device 600. The display device may include a touch based device that detects gestures such as a touch action. The display device may also provide feedback in response to detected gestures (or any other form of input). The program data 624 may also include, among other data, communication data 628 and information related to the communications, or the like, as described herein.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the example basic configuration 602 via the bus/interface controller 630. Some of the one or more output devices 642 include a graphics processing unit 648 and an audio processing unit 650, which may be configured to communicate to various external devices such as a display or speakers via one or more A/V ports 652. The one or more peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods for providing interest based navigation of communications. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

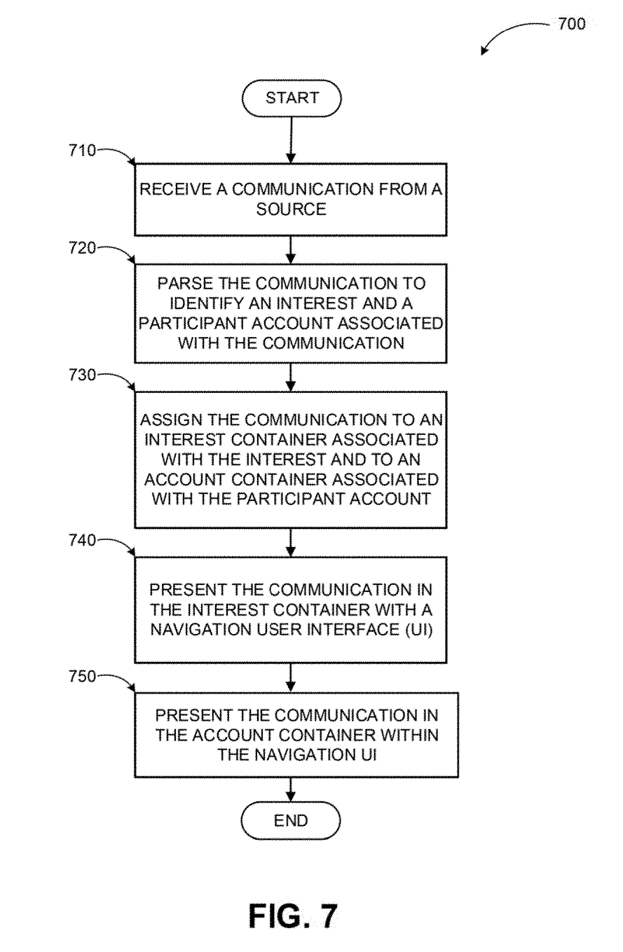

FIG. 7 is a logic flow diagram illustrating a process for providing interest based navigation of a communication, according to embodiments.

A process 700 may be implemented on a computing device, such as the computing device 600, or another system. As described, a participant may be allowed to interact with a communication application through an input device or a touch enabled display component of the computing device 600. The computing device 600 may provide a navigation user interface (UI) of the communication application to the participant.

The process 700 begins with operation 710, where the communication application may receive a communication from a source. The source may include a directory service, an online service, and/or a local data source, among others. At operation 720, the communication application may parse the communication to identify an interest and a participant account associated with the communication. The interest may include a favorite interest and/or a trending interest, among others.

At operation 730, the communication application may assign the communication to an interest container associated with the interest and to an account container associated with the participant account. The interest container may include a favorite container and/or a trending container, among others.

At operation 740, the communication application may present the communication in the interest container within the navigation UI. At operation 750, the communication application may present the communication in the account container within the navigation UI.

The operations included in process 700 are for illustration purposes. Interest based navigation of communications may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

A means for providing interest based navigation of a communication may be provided, which includes a means for receiving a communication from a source, a means for parsing the communication to identify an interest and a participant account associated with the communication, a means for assigning the communication to an interest container associated with the interest and to an account container associated with the participant account, a means for presenting the communication in the interest container within a navigation user interface (UI), and a means for presenting the communication in the account container within the navigation UI.

According to some embodiments, computing devices for providing interest based navigation of a communication are described. An example computing device may include a display device, a memory, and processors coupled to the memory and the display device. The processors may execute a communication application in conjunction with instructions stored in the memory. The communication application may include a classification engine and a rendering engine. The classification engine may be configured to receive a communication from a source, parse the communication to identify an interest and a participant account associated with the communication, and assign the communication to an interest container associated with the interest and to an account container associated with the participant account. The rendering engine may be configured to present, on the display device, the communication in the interest container within a navigation user interface (UI) and present, on the display device, the communication in the account container within the navigation UI.

According to other embodiments, the classification engine may be further configured to extract contextual information from the communication and analyze the contextual information to count a number of interactions with the communication. The number of interactions may include a number of comments, a number of shares, and/or a number of social media identifiers associated with the communication. The classification engine may be further configured to detect the number of interactions exceeding a threshold, label the communication with a favorite interest as the interest, and assign the communication to a favorite container as the interest container.

According to some embodiments, the classification engine may be further configured to detect an increase in a number of accesses to the communication during a time period, label the communication with a trending interest as the interest, and assign the communication to a trending container as the interest container.

In other examples, the classification engine may be further configured to identify keywords in the communication and analyze a number of actions associated with the keywords. The actions may include a search action, a copy action, and/or a paste action, among others. The classification engine may be further configured to detect the number of actions exceeding a threshold, label the communication as a favorite interest as the interest, and assign the communication to a favorite container as the interest container.

According to some embodiments, the classification engine may be further configured to identify the interest associated with the communication as a favorite interest and assign the communication to a favorite container as the interest container. In other examples, the classification engine may be further configured to detect a customization request to reassign the communication to a trending container, change the interest associated with the communication to a trending interest from the favorite interest, and reassign the communication to the trending container from the favorite container.

According to other embodiments, the classification engine may be further configured to identify the interest associated with the communication as a trending interest and assign the communication to a trending container as the interest container. In some examples, the classification engine may be further configured to detect a customization request to reassign the communication to a favorite container, change the interest associated with the communication to a favorite interest from the trending interest, and reassign the communication to the favorite container from the trending container. In examples, the source may include a directory service, an online service, and/or a local data source, among other examples.

According to some embodiments, methods executed on computing devices for providing interest based navigation of a communication, may be provided. An example method may include process steps, such as, receiving a communication from a source, parsing the communication to identify an interest and a participant account associated with the communication, assigning the communication to an interest container associated with the interest and to an account container associated with the participant account, presenting the communication in the interest container within a navigation user interface (UI), and presenting the communication in the account container within the navigation UI. The source includes a directory service, an online service, and/or a local data source, among other sources.

According to other embodiments, the example method may further include additional process steps, such as, receiving another communication from another source, parsing the other communication to identify another interest and another participant account associated with the other communication, and assigning the other communication to another interest container associated with the other interest and to another account container associated with the other participant account. The example method may further include, in other examples, additional process steps, such as, presenting the other communication in the other account container within the navigation UI, detecting an unread status of the other communication, and presenting an indicator in the navigation UI to notify the participant that the other communication is unread. In further examples of the method, additional process steps may include, at least, detecting an action on the other communication in the other account container within the navigation UI and presenting the other communication within a reading user interface (UI).

According to some embodiments, the example method may further include additional process steps, such as, detecting an unread status of the communication and presenting an indicator in the navigation UI to notify the participant that the communication is unread. In other examples, additional process steps may include detecting an action on the communication in the account container within the navigation UI and presenting the communication within a reading user interface (UI).

According to some examples, computer-readable memory devices with instructions stored thereon for providing interest based navigation of a communication may be provided. An example computer-readable memory device with instructions stored thereon for providing interest based navigation of a communication may include receiving a communication from a source, parsing the communication to identify an interest and a participant account associated with the communication, assigning the communication to an interest container associated with the interest and to an account container associated with the participant account, presenting the communication in the interest container within a navigation user interface (UI), and presenting the communication in the account container within the navigation UI. The source may include a directory service, an online service, and/or a local data source, among others.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing interest based navigation of a communication, the computing device comprising:
a display device;
a memory; and
one or more processors coupled to the memory and the display device, the one or more processors executing a communication application in conjunction with instructions stored in the memory, wherein the communication application includes:
a classification engine configured to:
receive a communication from a source;
parse the communication to identify an interest and a participant account associated with the communication; and
assign the communication to an interest container associated with the interest and to an account container associated with the participant account; and
a rendering engine configured to:
present, on the display device, the communication in the interest container within a navigation user interface (UI); and
present, on the display device, the communication in the account container within the navigation UI.

2. The computing device of claim 1, wherein the classification engine is further configured to:
extract contextual information from the communication; and
analyze the contextual information to count a number of interactions with the communication, wherein the number of interactions include one or more of a number of comments, a number of shares, and a number of social media identifiers associated with the communication.

3. The computing device of claim 2, wherein the classification engine is further configured to:
detect the number of interactions exceeding a threshold;
label the communication with a favorite interest as the interest; and
assign the communication to a favorite container as the interest container.

4. The computing device of claim 1, wherein the classification engine is further configured to:
detect an increase in a number of accesses to the communication during a time period;
label the communication with a trending interest as the interest; and
assign the communication to a trending container as the interest container.

5. The computing device of claim 1, wherein the classification engine is further configured to:
identify one or more keywords in the communication; and
analyze a number of actions associated with the one or more keywords, wherein the actions include a search action, a copy action, and a paste action.

6. The computing device of claim 5, wherein the classification engine is further configured to:
detect the number of actions exceeding a threshold;
label the communication as a favorite interest as the interest; and
assign the communication to a favorite container as the interest container.

7. The computing device of claim 1, wherein the classification engine is further configured to:
identify the interest associated with the communication as a favorite interest; and
assign the communication to a favorite container as the interest container.

8. The computing device of claim 7, wherein the classification engine is further configured to:
detect a customization request to reassign the communication to a trending container;
change the interest associated with the communication to a trending interest from the favorite interest; and
reassign the communication to the trending container from the favorite container.

9. The computing device of claim 1, wherein the classification engine is further configured to:
identify the interest associated with the communication as a trending interest; and
assign the communication to a trending container as the interest container.

10. The computing device of claim 9, wherein the classification engine is further configured to:
detect a customization request to reassign the communication to a favorite container;
change the interest associated with the communication to a favorite interest from the trending interest; and
reassign the communication to the favorite container from the trending container.

11. The computing device of claim 1, wherein the source includes one or more of a directory service, an online service, and a local data source.

12. A method executed on a computing device for providing interest based navigation of a communication, the method comprising:
receiving a communication from a source, wherein the source includes one or more of a directory service, an online service, and a local data source;
parsing the communication to identify an interest and a participant account associated with the communication;
assigning the communication to an interest container associated with the interest and to an account container associated with the participant account;
presenting the communication in the interest container within a navigation user interface (UI); and
presenting the communication in the account container within the navigation UI.

13. The method of claim 12, further comprising:
receiving another communication from another source;
parsing the other communication to identify another interest and another participant account associated with the other communication; and
assigning the other communication to another interest container associated with the other interest and to another account container associated with the other participant account.

14. The method of claim 13, further comprising:
presenting the other communication in the other account container within the navigation UI;
detecting an unread status of the other communication; and
presenting an indicator in the navigation UI to notify the participant that the other communication is unread.

15. The method of claim 14, further comprising:
detecting an action on the other communication in the other account container within the navigation UI; and
presenting the other communication within a reading user interface (UI).

16. The method of claim 13, further comprising:
detecting an unread status of the communication; and
presenting an indicator in the navigation UI to notify the participant that the communication is unread.

17. The method of claim 16, further comprising:
detecting an action on the communication in the account container within the navigation UI; and
presenting the communication within a reading user interface (UI).

18. A computer-readable memory device with instructions stored thereon for providing interest based navigation of a communication, the instructions comprising:
receiving a communication from a source, wherein the source includes one or more of a directory service, an online service, and a local data source;
parsing the communication to identify an interest and a participant account associated with the communication;
assigning the communication to an interest container associated with the interest and to an account container associated with the participant account;
presenting the communication in the interest container within a navigation user interface (UI); and
presenting the communication in the account container within the navigation UI.

19. The computer-readable memory device of claim 18, wherein the instructions further comprise:
receiving another communication from another source;
parsing the other communication to identify another interest and another participant account associated with the other communication;
assigning the other communication to another interest container associated with the other interest and to another account container associated with the other participant account;
presenting the other communication in the other account container within the navigation UI;
detecting an unread status of the other communication; and
presenting an indicator in the navigation UI to notify the participant that the other communication is unread.

20. The computer-readable memory device of claim 18, wherein the instructions further comprise:
detecting an unread status of the communication;
presenting an indicator in the navigation UI to notify the participant that the communication is unread;
detecting an action on the communication in the account container within the navigation UI; and
presenting the communication within a reading user interface (UI).
